(19) United States
(12) Patent Application Publication
(10) Pub. No.: US 2026/0098161 A1
(43) Pub. Date: Apr. 9, 2026

(54) LARGE PARTICLE SIZE FUNCTIONALIZED FLUOROPOLYMER LATEX PREPARATION

(71) Applicant: Arkema Inc., King of Prussia, PA (US)

(72) Inventors: Yuanqin LIU, King of Prussia, PA (US); Andrew KAHN, King of Prussia, PA (US)

(73) Assignee: ARKEMA INC., KING OF PRUSSIA, PA (US)

(21) Appl. No.: 19/113,962

(22) PCT Filed: Sep. 29, 2023
(86) PCT No.: PCT/US2023/034064

§ 371 Date: Mar. 21, 2025

Related U.S. Application Data
(60) Provisional application No. 63/411,828, filed on Sep. 30, 2022.

(51) Int. Cl. C09D 5/02; C08F 214/22; C08K 5/42; C09D 7/45; C09D 7/63; C09D 127/16; H01M 4/62; H01M 50/426

(52) U.S. Cl. CPC C09D 5/027; C08F 214/22; C09D 5/022; C09D 7/45; C09D 7/63; C09D 127/16; H01M 4/623; H01M 50/426; C08K 5/42

(57) ABSTRACT

Disclosed is a shear stable latex comprising functionalized fluoropolymer, a particle size modifier and a surfactant; said latex having solids content of at least 15 wt %, where the ratio of particle size modifier to surfactant is equal to or greater than 2 on a molar to molar basis.

### FIELD OF THE INVENTION

This invention describes the preparation of large particle size functionalized fluoropolymer latex. Large particle size functionalized fluoropolymer latex can be prepared by emulsion polymerization using fluoromonomer(s), surfactant, particle size modifier, functionalized chain transfer agent and initiator. These large particle size functionalized fluoropolymer latexes can be used in battery separator coatings.

### BACKGROUND OF THE INVENTION

Commercial grades of PVDF made by emulsion polymerization have a primary particle size of from 100 to 400 nm. There is no PVDF shear stable latex over 400 nm on the market. There is a need in the industry to increase the adhesion of battery separators to the electrodes without decreasing the porosity of the separator, which would decrease the movement of lithium ions, limiting the usefulness of the battery. Increasing the particle size of the PVDF binder may provide a solution to this problem.

As is well known in the art, latexes are more difficult to stabilize at higher polymer concentrations. In addition, many salts are known to destabilize latexes. It is also well known that larger particles size tend to destabilize the latex and limit higher polymer concentrations. There is a need to provide shear stable latexes with larger particle size fluoropolymers. The fact that the present invention provides good latex stabilization is unexpected. Indeed, the particular effectiveness of this invention is highlighted by that fact that shear stable latexes can be prepared with a large particle size in the presence of the particle size modifier that contain a high solids content of functionalized fluoropolymer in the latex (exceeding 15 wt %, preferable exceeding 20 wt % of the total reaction mixture).

The inventors have found that by utilizing certain particle size modifiers in preparing functionalized fluoropolymers, a primary particle size of the functionalized fluoropolymer can be increased to greater than 400 nm as compared to the same polymerization process without using the particle size modifiers. The use of these particle size modifiers makes it possible to prepare functionalized fluoropolymer shear stable latex containing a high level of dispersed functionalized fluoropolymer and having a primary particle size of 400 nm or more. This result is surprising because functionalized fluoropolymers prepared by emulsion polymerization typically results in a particle of less than 400 nm.

### SUMMARY OF THE INVENTION

The invention provides for a shear stable latex comprising functionalized fluoropolymer, a particle size modifier and a surfactant; said latex having solids content of at least 15 wt %, where the ratio of particle size modifier to surfactant is equal to or greater than 2 on a molar to molar basis, wherein the volume average particle size of the functionalized fluoropolymer in the latex is greater than 400 nm and less than 3000 nm, preferably greater than 450 nm and less than 2000 nm, as measured by light scattering.

In the case of multi modal particle size latexes at least 20% and more preferably at least 30%, most preferably at least 35% of the total number of functionalized fluoropolymer particles in the latex have a volume average primary particle size of greater than 475 nm and less than 2000 nm, more preferably greater than 500 and less than 2000 nm.

The invention provides a method of making a functionalized fluoropolymer having a large particle size. The method comprises:
(a) contacting an aqueous mixture comprising a particle size modifier, a surfactant, a functional chain transfer agent and a radical initiator with a monomer feed comprising one or more fluoromonomers;
(b) initiating polymerization of the one or more fluoromonomers, thereby forming a functionalized fluoropolymer shear stable latex.
wherein the surfactant comprises a non-fluorinated surfactant; and wherein the functionalized fluoropolymer is thermoplastic and comprises at least 71 wt % vinylidene fluoride.

Embodiments of the invention include the following embodiments. Embodiment 1 is an aqueous latex comprising: a surfactant, a particle size modifier and functionalized fluoropolymer; wherein the surfactant comprises at least one of an alkanesulfonate selected from the group consisting of C7-C20 1-alkanesulfonates, C7-C20 2-alkanesulfonates, C7-C20 1,2-alkanedisulfonates, and mixtures thereof, wherein the particle size modifier comprises MX where M is an alkali metal or NH4, preferably an alkali metal, and X is halide, wherein the ratio of particle size modifier to surfactant is equal to or greater than 2 on a molar to molar basis, wherein the functionalized fluoropolymer concentration is at least 15 wt percent, preferably at least 20 wt percent based on total weight of the aqueous functionalized fluoropolymer dispersion, wherein the volume average particle size of the functionalized fluoropolymer in the latex is greater than 400 nm and less than 3000 nm, preferably greater than 450 nm and less than 2000 nm as measured by light scattering, wherein said latex is shear stable as measured by a latex shear stability test where the viscosity is less than 100 cps after 30 minutes at 2500 rpm and 25 C.

Embodiment 2 is the aqueous latex of embodiment 1, wherein the volume average particle size of the functionalized fluoropolymer in the latex is greater than 500 nm and less than 1500 nm as measured by light scattering

Embodiment 3 is the aqueous latex of any one or more of the preceding embodiments, wherein the functionalized fluoropolymer comprises at least 50 wt % vinylidene fluoride.

Embodiment 4 is the aqueous latex of any one or more of the preceding embodiments, wherein the fluoromonomers comprise hexafluoropropylene.

Embodiment 5 is the aqueous latex of any one or more of the preceding embodiments, wherein M is an alkali metal.

Embodiment 6 is the aqueous latex of any one or more of the preceding embodiments, wherein M is selected from the group consisting of Na, Cs, and Li.

Embodiment 7 is the aqueous latex of any one or more of the preceding embodiments, wherein X is Cl or Br, preferably Cl.

Embodiment 8 is the aqueous latex of of any one or more of embodiments 1 to 4, wherein the particle size modifier comprises at least one of NaCl, CsCl, LiCl or NH4Cl.

Embodiment 9 is the aqueous latex of any one or more of embodiments 1 to 4, wherein M is lithium, sodium, cesium or NH4 and X is Cl.

Embodiment 10 is the aqueous latex of any one or more of the preceding embodiments, wherein the molar ratio of particle size modifier to surfactant is at least 3.

Embodiment 11 is the aqueous latex of any one or more of the preceding embodiments, wherein the molar ratio of particle size modifier to surfactant is at least 2, up to 15, preferably up to 12.

Embodiment 12 is the aqueous latex of any one or more of the preceding embodiments, wherein the functionalized fluoropolymer exhibits a multimodal particle size distribution.

Embodiment 13 provides a method of increasing the volume average particle size of a functionalized fluoropolymer, the method comprising:
(a) contacting an aqueous mixture comprising a surfactant, a functional chain transfer agent, a particle size modifier with a monomer feed comprising one or more fluoromonomers and a radical initiator feed; and
(b) initiating the polymerization of said one or more fluoromonomers, thereby forming a functionalized fluoropolymer shear stable latex;
wherein the surfactant comprises an alkanesulfonate selected from C7-C20 1-alkanesulfonates, C7-C20 2-alkanesulfonates, C7-C20 1,2-alkanedisulfonates, and mixtures thereof; wherein the particle size modifier comprises MX, wherein the M is an alkali metal or NH4 and X is a halide, and wherein the ratio of particle size modifier to surfactant is 2 or greater on a molar to molar basis.

Embodiment 14 is the method of embodiment 13, wherein the fluoromonomers comprise vinylidene fluoride.

Embodiment 15 is the method of embodiment 13 or 14, wherein the fluoromonomers comprise hexafluoropropylene.

Embodiment 16 is the method of any one or more of embodiments 13 to 15, wherein the alkanesulfonate is selected from C8-C12 1-alkanesulfonates, C8-C12 2-alkanesulfonates, C8-C12 1,2-alkanedisulfonates, and mixtures thereof.

Embodiment 17 is the method of any one or more of embodiments 13 to 15, wherein the surfactant comprises an alkanesulfonate selected from 1-octanesulfonates, 2-octanesulfonates, 1,2-octanedisulfonates, 1-decanesulfonates, 2-decanesulfonates, 1,2-decanedisulfonates, 1-dodecanesulfonates, 2-dodecanesulfonates, 1,2-dodecanedisulfonates, and combinations thereof.

Embodiment 18 is the method of any one or more of embodiments 13 to 15, wherein the alkanesulfonate comprises a 1-octanesulfonate.

Embodiment 19 is the method of any one or more of embodiments 13 to 15, wherein the alkanesulfonate is a sodium, potassium, or ammonium alkanesulfonate, or a mixture thereof.

Embodiment 20 is the method of any one or more of embodiments 13 to 19, wherein the particle size modifier is MX where M is a metal or NH₄ and X is halide.

Embodiment 21 is the method of any one or more of embodiments 13 to 20, wherein M is an alkali metal or NH₄.

Embodiment 22 is the method of any one or more of embodiments 13 to 20, wherein M is selected from the group consisting of selected from Na, Cs, and Li.

Embodiment 23 is the method of any one or more of embodiments 13 to 22, wherein X is Cl or Bromide, preferably Cl.

Embodiment 24 is the method of any one or more of embodiments 13 to 19, wherein the particle size modifier comprises at least one of NaCl, CsCl, LiCl or NH₄Cl.

Embodiment 25 is the method of any one or more of embodiments 13 to 24, wherein the functionalized fluoropolymer comprises a copolymer comprising vinylidene fluoride and hexafluoropropylene monomer units.

Embodiment 26 is the method of any one or more of embodiments 13 to 25, wherein the functionalized fluoropolymer comprises at least 75 wt % vinylidene fluoride units.

Embodiment 27 is the method of any one or more of embodiments 13 to 27, wherein the radical initiator comprises a persulfate salt.

Embodiment 28 is the method of any one or more of embodiments 13 to 27, wherein the wt % of functionalized fluoropolymer in the latex, after step (b), is at least 15 wt % of the latex, preferably at least 20 wt %.

Embodiment 29 provides a method of making a multimodal functionalized fluoropolymer dispersion, the method comprising:
(a) contacting an aqueous mixture comprising a surfactant, a functional chain transfer agent, a particle size modifier and monomer feed comprising one or more fluoromonomers and a radical initiator; and
(b) providing sufficient heat and pressure to effect a polymerization of said one or more fluoromonomers, thereby forming a functionalized fluoropolymer dispersion;
wherein the surfactant comprises at least one an alkanesulfonate selected from the group consisting of C7-C20 linear 1-alkanesulfonates, C7-C20 linear 2-alkanesulfonates, C7-C20 linear 1,2-alkanedisulfonates, and mixtures thereof; and, comprises at least 50 wt % vinylidene fluoride wherein the particle size modifier comprises MX where M is lithium, sodium or NH₄ and X is Cl, wherein the ratio of particle size modifier to surfactant is greater than 2 on a molar to molar basis.

Embodiment 29 provides for the use of the aqueous latex of any one or more of embodiments 1 to 12, in lithium ion battery applications, preferably as a separator coating or electrode binder.

### DETAILED DESCRIPTION OF THE INVENTION

The invention provides for a shear stable functionalized fluoropolymer latex having at least 20% solid content and having a volume average primary particle size of 400 nm or greater, preferably 450 nm or greater, most preferably greater than 500 nm. The invention also provides for a method to make a shear stable functionalized fluoropolymer latex having a volume average primary particle size of 400 nm of greater, preferably 450 nm or greater, most preferably greater than 500 nm, wherein the functionalized fluoropolymers of the invention are thermoplastic. Shear stable is determined using the Latex shear stability test method described herein.

The functionalized fluoropolymers are prepared as an aqueous dispersion polymerization reaction mixture (typically referred to as an emulsion or latex) that includes one or more surfactants, at least one functionalized chain transfer agent and uses one or more radical initiators.

The polymerization to prepare the functionalized fluoropolymers may be performed in the presence of chain transfer agents to regulate molecular weight, optionally buffering agents to maintain a desired pH range during the polymerization and optionally antifoulants to reduce or eliminate adhesion of the polymer to the inside surfaces of the polymerization vessel.

The term “fluoropolymer” as used for purposes of this invention means a polymeric material comprising at least 71 wt % of fluorinated monomer units. Suitable fluorinated monomer are described below. The remainder of the units may be one or more fluoromonomers, ethene, propene, (meth) acrylates, (meth) acrylic acid, or other monomer known to copolymerize with fluoromonomer. The fluoropolymer of the invention is a functional fluoropolymer comprising a functional group. By functional group we mean a substituent or moiety that causes the molecule's characteristic chemical reactions, such as carboxylic acid, carboxylate, hydroxyl, carbonyl, ketone, aldehyde, haloformyl, ester, carboxamide, amidine, amine, imine, imide, nitrile, nitro, pyridyl, sulfhydryl, sulfide, sulfinyl, isothiocyanate, carbonothioyl, and combinations thereof.

In a preferred embodiment, the functionalized fluoropolymer of the invention comprises vinylidene fluoride and may be a homopolymer or a copolymer of vinylidene fluoride. Preferably the at least 71 wt % of fluorinated monomer unit is vinylidene fluoride.

The functionalized fluoropolymers may be homopolymers, copolymers, terpolymers or polymers derived from more than three monomers. The term copolymer as used herein includes any polymer comprising two or more different monomer units. They are typically thermoplastic, where “thermoplastic” means the ability to be formed into shapes by the application of heat and (typically) pressure, such as is done in molding and extrusion processes. Exemplary polymers made by the methods of the invention include polyvinylidene fluoride homopolymer; copolymers, terpolymers and higher polymers having a vinylidene fluoride content of at least 71 wt %, and typically at least 75 wt %. Levels up to about 99 wt % VDF monomer units may be found in some exemplary embodiments of the invention. Specific preferred functionalized fluoropolymers according to the invention include, for example, functionalized copolymers of vinylidene fluoride with hexafluoropropylene, or tetrafluoroethylene, or trifluoroethylene, and terpolymers of vinylidene fluoride with tetrafluoroethylene and hexafluoropropylene or with tetrafluoroethylene and trifluoroethylene. Other copolymers and terpolymers may contain fluoromonomers other than those listed above, in combination with vinylidene fluoride. Suitable examples of such other fluoromonomers for use according to the invention will be detailed further below.

### Surfactant

The surfactant used in the polymerization comprises at least one alkanesulfonate. As used herein, the term “alkanesulfonate(s)” and terms ending with the term “sulfonate(s)” refer to alkali metal, ammonium, or monoalkyl-, dialkyl-, trialkyl-, or tetraalkyl-substituted ammonium salts of alkanesulfonic or alkanedisulfonic acids. Sodium, potassium, and ammonium alkanesulfonates, or mixtures of any of these, are typically used.

Preferably, the surfactant used in the polymerization comprises at least one alkanesulfonate selected from the group consisting of C7-C20 1-alkanesulfonates, C7-C20 2-alkanesulfonates, C7-C20 1,2-alkanedisulfonates, and mixtures thereof; more preferably the alkanesulfonate is selected from C8-C12 1-alkanesulfonates, C8-C12 2-alkanesulfonates, C8-C12 1,2-alkanedisulfonates, and mixtures thereof. Preferably, the alkanesulfonate is a sodium, potassium, or ammonium alkanesulfonate, or a mixture thereof. Preferably, the alkanesulfonate is linear. One or more alkane sulfonates can be used in the invention.

Example alkanesulfonates include but are not limited to, 1-octanesulfonates, 2-octanesulfonates, 1,2-octanedisulfonates, 1-decanesulfonates, 2-decanesulfonates, 1,2-decanedisulfonates, 1-dodecanesulfonates, 2-dodecanesulfonates, 1,2-dodecanedisulfonates.

1-octanesulfonate is a preferred surfactant.

### Fluoromonomer

The term “fluoromonomer” as used according to the invention means a fluorinated and olefinically unsaturated monomer capable of taking part in a free radical polymerization reaction. The fluoromonomers used according to the invention may consist only of vinylidene fluoride, or they may contain any of a wide variety of other fluoromonomers known in the art. Suitable fluoromonomers for use according to the invention include at least one fluorine atom, and may for example incorporate a fluoroalkyl group, a fluoroalkoxy group, or a vinylic fluorine atom.

Suitable exemplary fluoromonomers for use according to the invention include, vinylidene fluoride (VDF), tetrafluoroethylene (TFE), trifluoroethylene (TrFE), chlorotrifluoroethylene (CTFE), 1,2-difluoroethylene, perfluorobutylethylene (PFBE), hexafluoropropene (HFP), vinyl fluoride (VF), pentafluoropropene, 2,3,3,3-tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, one or more of partly or fully fluorinated alpha-olefins such as 3,3,3-trifluoro-1-propene, 2-trifluoromethyl-3,3,3-trifluoropropene, 1,2,3,3,3-pentafluoropropene, 3,3,3,4,4-pentafluoro-1-butene, hexafluoroisobutylene (HFIB), fluorinated dioxoles, such as perfluoro (1,3-dioxole) and perfluoro (2,2-dimethyl-1,3-dioxole) (PDD), partially- or per-fluorinated alpha olefins of C4 and higher, partially- or per-fluorinated cyclic alkenes of C3 and higher, partly fluorinated allylic, or fluorinated allylic monomers, and combinations thereof.

In a preferred embodiment, VDF is used in combination with at least one fluoromonomer selected from the group consisting of tetrafluoroethylene (TFE), chlorotrifluoroethylene (CTFE), and hexafluoropropene (HFP).

### Particle Size Modifier

The particle size modifier comprises MX where M is an alkali metal or NH₄, preferably an alkali metal, and X is halide. Preferably M is an alkali metal. Preferably X is Cl or Br, preferably Cl.

Example M include Na, Cs, and Li.

Example particle size modifier include NaCl, CsCl, LiCl or NH₄Cl.

Preferably M is lithium, sodium, cesium or NH₄ and X is Cl.

The molar ratio of particle size modifier to surfactant is equal to or greater than 2 on a molar to molar basis, preferably 3 or greater.

In some embodiments the molar ratio of particle size modifier to surfactant is at least 2, and up to 15, preferably between 2 and 12.

The functionalized fluoropolymer may exhibit a monomodal particle size distribution or a multimodal particle size distribution.

### Radical Initiator

Radical initiators suitable for use according to the invention are compounds, or combinations of compounds, that are capable of providing a source of free radicals, either spontaneously or by exposure to heat or light. The radical initiator is added to the reaction mixture in an amount sufficient to initiate and maintain the polymerization reaction at a desired reaction rate. Suitable nonlimiting classes of initiators include persulfate salts, peroxides, peroxydicarbonates, azo compounds, and redox systems, all of which are well known in the art. As used herein, the term “ionic initiator” means a radical initiator that includes at least one salt containing a metal cation and/or an ammonium or substituted ammonium cation. The term “radical” and the expression “free radical” refer to a chemical species that contains at least one unpaired electron.

The preferred radical initiator comprises a persulfate salt, such as sodium persulfate, potassium persulfate, or ammonium persulfate. The amount of persulfate salt added to the reaction mixture (based upon the total weight of monomer added to the reaction mixture) is typically from about 0.005 to about 1.0 wt % based on the total weight of monomer(s) used in the reaction.

The radical initiator may comprise an organic peroxide such as an alkyl, dialkyl, or diacyl peroxide, peroxydicarbonates, and peroxy esters or mixtures thereof. A preferred dialkyl peroxide is di-tert-butylperoxide (DTBP), which may be added to the reaction mixture in an amount from about 0.01 to about 5 weight percent on total monomer, and is preferably added in an amount from about 0.05 to about 2.5 wt % based on the total weight of monomer(s) used in the reaction. Preferred peroxydicarbonate initiators are di-n-propyl peroxydicarbonate and diisopropyl peroxydicarbonate, which may be added to the reaction mixture in an amount from about 0.5 to about 2.5 weight percent on total monomer. Peroxy ester initiators include tert-amyl peroxypivalate, tertbutyl peroxypivalate, and succinic acid peroxide.

The radical initiator may comprise an azo initiator, such as 2,2′-azobis (2 methyl-propionamidine) dihydrochloride.

The radical initiator may comprise a redox system. By “redox system” is meant a system comprising an oxidizing agent, a reducing agent and optionally, a promoter as an electron transfer medium. Oxidizing agents include, for example, persulfate salts; peroxides, such as hydrogen peroxide; hydroperoxides such as tert-butyl hydroperoxide and cumene hydroperoxide; and oxidizing metal salts such as, for example, ferric sulfate. Reducing agents include, for example, sodium formaldehyde sulfoxylate, sodium and potassium sulfite, ascorbic acid, bisulfite, metabisulfite, and reduced metal salts. The promoter is a component of the redox system which, in different oxidation states, is capable of reacting with both the oxidant and the reducing agent, thereby accelerating the overall reaction. Promoters include, for example, transition metal salts such as ferrous sulfate. In redox systems, the oxidizing agent and the reducing agent may be utilized in an amount from about 0.01 to about 0.5 wt % based on the total weight of monomer(s) used in the reaction. The optional promoter may be utilized in an amount from about 0.005 to about 0.025 wt % based on the total weight of monomer(s) used in the reaction. Redox systems are described in G. S. Misra and U. D. N. Bajpai, Prog. Polym. Sci., 1982, 8 (1-2), pp. 61-131.

### Chain Transfer Agent

Chain-transfer agents may be added to the polymerization mixture to regulate the molecular weight of the product. They may be added in a single portion at the beginning of the reaction, or incrementally or continuously throughout the reaction. The amount and mode of addition of chain-transfer agent, if any, depend on the activity of the particular agent employed, and on the desired molecular weight of the polymer product. The amount of chain-transfer agent added to the polymerization reaction is typically from about 0.05 to about 5 wt %, more typically from about 0.1 to about 2 wt %, based on the total weight of monomers used in the reaction.

Oxygenated compounds such as alcohols, carbonates, ketones, esters, and ethers may serve as chain-transfer agents. Examples of oxygenated compounds useful as chain-transfer agents include isopropyl alcohol ethyl acetate, methyl acetate, diethyl carbonate, acetone, ethanol, n-propanol, acetaldehyde, propylaldehyde, and ethylpropionate. Other classes of compounds which may serve as chain-transfer agents in the polymerization of halogen-containing monomers include, for example, halocarbons and hydrohalocarbons, and chlorocarbons such as carbon tetrachloride. Simple alkanes or branched alkanes such as ethane, propane or 2-ethylhexane may also function as chain-transfer agents.

Low molecular weight polymers (less than 20000 g/mol) having functional groups such as acrylic acid, phosphonic acid, sulfonic acid, maleic acid, carboxylic acid, carboxylate, hydroxyl, carbonyl, ketone, aldehyde, haloformyl, ester, carboxamide, amidine, amine, imine, imide, nitrile, nitro, pyridyl, sulfhydryl, sulfide, sulfinyl, isothiocyanate, and carbonothioyl may serve as functional chain transfer agents as described in WO 2016/149238. Benzenesulfonic acid may be used as a functional chain transfer agent. Any chain transfer agent that provide a functionality to the polymer may serve as a functional chain transfer agent. In the case of acid groups, the functional groups may be partially or fully neutralized and/or esterified.

Preferred are chain transfer agents having ionic functionality. In one preferred embodiment the chain transfer agent has acidic functionality.

### Buffering Agent

The polymerization reaction mixture may optionally contain a buffering agent to maintain a controlled pH throughout the polymerization reaction. The pH is typically controlled within the range of from about 3 to about 8, to minimize undesirable color development in the product.

Buffering agents may comprise an organic or inorganic acid or an alkali metal salt thereof, or base or salt of such organic or inorganic acid, that has at least one pKa value and/or pkb value in the range of from about 4 to about 10, usually from about 4.5 to about 9.5. Suitable exemplary buffering agents for use according to the invention include phosphate buffers and acetate buffers, are well known in the art.

Buffering agents are especially useful when a persulfate salt (e.g. potassium persulfate) is employed as the radical initiator. A preferred buffering agent in such a situation is sodium acetate. A preferred amount of sodium acetate buffer is from about 50 wt % to about 150 wt %, based on the weight of the initiator added to the reaction. In one typical example embodiment, the initiator feed comprises approximately equal weights of potassium persulfate and sodium acetate in aqueous solution.

### Antifoulant

The optional addition of an antifoulant such as paraffin wax or hydrocarbon oil to the reaction mixture is typically performed to minimize or prevent adhesion of functionalized fluoropolymer to the reactor components. Any long chain saturated hydrocarbon wax or oil can perform this function. The oil or wax is added to the reactor prior to formation of functionalized fluoropolymer, in an amount sufficient to minimize the formation of polymer adhesions to the reactor components.

### Polymerization Process

The general procedure may be followed: to a reactor is initially added deionized water, functional chain transfer agent, surfactant and particle size modifier, followed by deoxygenation (removal of oxygen). The reactor may be a pressurized polymerization reactor equipped with a stirrer and heat control means. The stirring may be constant, or may be carried to optimize process conditions during the course of stabilizer preparation. After the reactor reaches the desired temperature, a certain amount of fluoromonomer and optional comonomer(s) is added to the reactor. The ratio of the monomer and comonomer(s) can be constant throughout the polymerization or can be varied over the polymerization process. The initiator solution is fed to the reactor with a suitable flow rate to maintain the desired rate of reaction. After reaching the desired monomer(s) amount, the feed of monomer(s) can be stopped. The unreacted monomers can be vented and the prepared latex can be collected through a drain port or by other collection means. The latex can be kept in the aqueous media for subsequent application or use.

Preparation of functionalized fluoropolymers according to the invention is typically performed in a pressurized reactor equipped with an efficient agitation system, using equipment known in the art. The pressure used for polymerization may be selected from a wide range of pressures, from about 280 to about 20,000 kPa, depending on the capabilities of the reaction equipment, the initiator system chosen, and the monomer(s) composition used. The polymerization pressure is typically from about 2,000 to about 11,000 kPa, and most typically from about 2,750 to about 6,900 kPa. The polymerization temperature may vary from about 20° C. to about 160° C., depending on the initiator system chosen, and is typically from about 35° C. to about 130° C., and most typically from about 65° C. to about 95° C.

### Characterization of the Latex

The present invention provides for a functionalized fluoropolymer latex that is shear stable as measured by a latex shear stability test method in which the latex is agitated as described in the Test Methods Section (below) for 30 min at 2500 rpm at 25 C. If the latex maintains a viscosity of 100 cps or less, under these test conditions, it is a shear stable latex.

The volume average particles size in the inventive functionalized fluoropolymer latex is greater than 400 nm, preferably greater than 450 nm and most preferably greater than 500 nm average volume particles size in the inventive functionalized fluoropolymer latex is less than 3 microns.

In the case of latexes having multi modal particle size distributions at least 20% and more preferably at least 30%, most preferably at least 35% of the total number of fluoropolymer particles in the latex have a volume average primary particle size of greater than 475 nm and less than 2000 nm, more preferably greater than 500 and less than 2000 nm or greater than 525 nm and less than 2000 nm.

The shear stable latex can have a solids content of greater than 20 wt %, preferably greater than 22 wt %.

The functionalized fluoropolymer may have a melt viscosity of 50 kPoise or greater using the present inventive method.

The following examples are provided to illustrate the practice of the invention, and are not to be construed as limiting the scope of the claims. In the examples, unless otherwise noted, deionized water and ACS reagent grade ingredients were used.

### EXAMPLES

### Test Methods

Light scattering test method for latex particle size: Nicomp CW380 Particle Size Analyzer (light scattering) is used to measure the particle size of the latex particles. The Volume Average particle size is used.

Latex shear stability test method
(a) Filter 450.0 grams of the latex sample through a 125 micron pore size screen. Add 0.5 gram of defoamer (TEGO® Foamex 840 from Evonik) to the latex sample.
(b) Pour the sample into a 500 ml container. Agitate the sample (2500 rpm) at room temperature using a Caframo Universal overhead stirrer (Model BDC3030) Monitor the latex while agitating noting any change in consistency. Run the agitator for 30 minutes or until the latex stops moving or coagulates.
(c) After 30 minutes of agitation, the latex is filtered through a 125 micron pore size screen. Coagulum (if any) collected on the screen is weighted. Brookfield viscosity is measured on the filtered latex using a Brookfield viscometer (Model DV-II+ Pro, spindle #34, 35 rpm) at 25° C.
(d) The latex sample is considered shear stable if the collected coagulum (wet coagulum) is less than 1.0 wt % (4.5 g) of the total latex and the Brookfield viscosity is less than 100 cps after 30 minutes of agitation.

Melt viscosity (MV): ASTM method D3835-16 (capillary rheometry). Measurements are reported at 232° C., 100 s⁻¹. Values are reported in kiloPoise (kP).

Solids-Weigh a sample of latex. Dry the sample at 100 C for 24 hours and weigh the dried sample. % solids=dry weight/total weight.

Four sets of examples were prepared. The synthesis parameters and the latex characterization are summarized in the tables below.

A general procedure for preparing large particle size shear stable fluoropolymer latex

To a 2 gallon reactor were added, 4500 g of deionized water, surfactant, functional chain transfer agent, and particle size modifier. (see table below for amounts) The autoclave was agitated at 72 rpm, heated to 83 C and pressurized to 650 psi (4481 KPa) with HFP and vinylidene fluoride. A feed of 2.0 wt % KPS aqueous solution was started at 180.0 mL/h. Upon onset of a pressure drop, indicating the polymerization had initiated, the KPS feed rate was reduced to 25.0 mL/h and the pressure was maintained by additional VDF and HFP feed. Feeds were continued in this fashion, until a desired amount of VDF and HFP had been reached. 5.0 wt % PAA (polyacrylic acid) solution was fed into the reactor at 160 mL/h during the second half of the VDF feed. The reaction temperature was maintained at 83 C for an additional 30 minutes. Then the pressure was allowed to autogenously decrease for 10 minutes at which point the reactor was vented to atmospheric pressure and cooled to room temperature. Product was discharged from the reactor.

The examples were made following the above procedure. The monomer, surfactant, and particle size modifier used in each example are listed in the Tables.

TABLE 1A

| | | | | Surf. (wt. | Particle size | PSM (wt. | |
|---|---|---|---|---|---|---|---|
| | VDF | HFP | | ppm based on | modifier | ppm based on | PSM/Surf. |
| Example | (mL) | (mL) | Surfactant | total monomer) | “PSM” | total monomer) | (mol./mol.) |
| 1 | 1467 | 35 | SOS | 1000 | NaCl | 2000 | 7.9 |
| 2 | 1667 | 100 | SOS | 500 | NaCl | 2000 | 15.8 |

TABLE 1B

| | | | | Vol. average | PAA (wt % |
|---|---|---|---|---|---|
| | PSM/Surf. | | Melt Visc | Latex Particle | based on |
| Example | (mol./mol.) | Solids | (kP@100−s) | size (nm) | total monomer) |
| 1 | 7.9 | 24.4% | 64.5 | 519 (169/12.7%, | 0.22 |
| | | | | 548/87.3%) | |
| 2 | 15.8 | coagulated | 62.2 | coagulated | 0.29 |

1. An aqueous latex comprising:
a surfactant, a particle size modifier and functionalized fluoropolymer;
wherein the surfactant comprises at least one of an alkanesulfonate selected from the group consisting of C7-C20 1-alkanesulfonates, C7-C20 2-alkanesulfonates, C7-C20 1,2-alkanedisulfonates, and mixtures thereof,
wherein the particle size modifier comprises MX where M is an alkali metal or NH₄, preferably an alkali metal, and X is halide,
wherein the ratio of particle size modifier to surfactant is equal to or greater than 2 on a molar to molar basis,
wherein the functionalized fluoropolymer concentration is at least 15 wt percent, preferably at least 20 wt percent based on total weight of the aqueous functionalized fluoropolymer dispersion,
wherein the volume average particle size of the functionalized fluoropolymer in the latex is greater than 400 nm and less than 3000 nm
wherein said latex is shear stable as measured by a latex shear stability test where the viscosity is less than 100 cps after 30 minutes at 2500 rpm and 25 C.

2. The aqueous latex of claim 1, wherein the volume average particle size of the functionalized fluoropolymer in the latex is greater than 500 nm and less than 1500 nm.

3. The aqueous latex of claim 1, wherein the functionalized fluoropolymer comprises at least 50 wt % vinylidene fluoride.

4. The aqueous latex of claim 1, wherein the fluoromonomers comprise hexafluoropropylene.

5. The aqueous latex of claim 1, wherein M is an alkali metal.

6. The aqueous latex of claim 1, wherein M is selected from the group consisting of Na, Cs, and Li.

7. The aqueous latex of claim 1, wherein X is Cl or Br.

8. (canceled)

9. The aqueous latex of claim 1, wherein M is lithium, sodium, cesium or NH₄ and X is Cl.

10. The aqueous r latex of claim 1, wherein the molar ratio of particle size modifier to surfactant is at least 3.

11. The aqueous latex of claim 1, wherein the molar ratio of particle size modifier to surfactant is at least 2 and up to 15.

12. (canceled)

13. A method of increasing the volume average particle size of a functionalized fluoropolymer, the method comprising:
a) contacting an aqueous mixture comprising a surfactant, a functional chain transfer agent, a particle size modifier with a monomer feed comprising one or more fluoromonomers and a radical initiator feed; and
b) initiating the polymerization of said one or more fluoromonomers, thereby forming a functionalized fluoropolymer shear stable latex;
wherein the surfactant comprises an alkanesulfonate selected from C7-C20 1-alkanesulfonates, C7-C20 2-alkanesulfonates, C7-C20 1,2-alkanedisulfonates, and mixtures thereof;
wherein the particle size modifier comprises MX, wherein the M is an alkali metal or NH₄ and X is a halide, and
wherein the ratio of particle size modifier to surfactant is 2 or greater on a molar to molar basis.

14. The method of claim 13, wherein the fluoromonomers comprise vinylidene fluoride.

15. (canceled)

16. The method of claim 13, wherein the alkanesulfonate is selected from C8-C12 1-alkanesulfonates, C8-C12 2-alkanesulfonates, C8-C12 1,2-alkanedisulfonates, and mixtures thereof.

17. (canceled)

18. The method of claim 13, wherein the alkanesulfonate comprises a 1-octanesulfonate.

19. (canceled)

20. (canceled)

21. (canceled)

22. The method of claim 13, wherein M is selected from the group consisting of selected from Na, Cs, and Li.

23. The method of claim 13, wherein X is Cl or Bromide.

24. The method of claim 13, wherein the particle size modifier comprises at least one of NaCl, CsCl, LiCl or NH₄Cl.

25. (canceled)

26. The method of claim 13, wherein the functionalized fluoropolymer comprises at least 75 wt % vinylidene fluoride units.

27. (canceled)

28. (canceled)

29. (canceled)

30. (canceled)

31. A battery separator coating composition comprising the aqueous latex of claim 1.

32. A battery electrode coating composition comprising the aqueous latex of claim 1.
